(19) United States
(12) Patent Application Publication
(10) Pub. No.: US 2013/0009857 A1
(43) Pub. Date: Jan. 10, 2013

(54) METHOD AND APPARATUS FOR ADAPTIVE MAIN BACK-LIGHT BLANKING IN LIQUID CRYSTAL DISPLAYS

(76) Inventor: Emil Tchoukaleysky, Toronto (CA)

(21) Appl. No.: 13/635,005

(22) PCT Filed: Apr. 27, 2010
(86) PCT No.: PCT/IB2010/000949

§ 371 Date: Sep. 14, 2012

(51) Int. Cl. G09G 3/36

(52) U.S. Cl. 345/102

(57) ABSTRACT

The present principles are directed towards enhancing the reproduction of dynamic scenes on Liquid Crystal Display (LCD) monitors by employing temporal control over the duration of frame blanking of the display back-light. Particularly, the greater the image difference between neighboring frames, the wider the main back-light frame blanking becomes, and vice versa—smaller image difference between consecutive frames will automatically inflict narrower main back-light frame blanking.

### BACKGROUND

1. Technical Field

The present invention relates to liquid crystal displays, and more particularly, it relates to enhancing the reproduction of dynamic scenes on Liquid Crystal Display (LCD) monitors by controlling frame blanking of the display back-light.

2. Related Art

Those of skill in the art will recognize that the secondary motion blur in LCD monitors is due to the fact that LCD picture element (pixel) intensity stays constant without any interruption over one or more television frames, until the input video information for this pixel changes. There is no native video frame or field refresh, which was typical for the Cathode Ray Tube (CRT) monitors. This refresh contributed for preparedness of the Human Visual System (HVS) to perceive the new content in the next video frame. The sudden change of pixel intensity in LCD conflicts with the previous intensity, retained on the human eye retina, thus creating motion blur.

Recently, some LCD monitor manufacturers began producing displays where the traditional fluorescent back-light, being the optical source for the image, is replaced with a Light Emitting Diode (LED) matrix. This made practical the introduction of frame refresh, or LED back-light frame blanking, during a small time interval in the video frame, similar to the CRT technology. Back light flashing is another expression for this process.

Admitting the progress, one problem remains unsolved for the case of LCD monitors: there is no relation between the back-light frame blanking and the image content, so some motion blur remains perceived by the HVS. In nature we see evolving scene changes, while in a television system the dynamics are conveyed via sequence of strobed images, and the introduction of the simple back-light frame blanking addresses only part of the problem.

### SUMMARY

According to an implementation, the method for controlling main back-light frame blanking in liquid crystal displays includes comparing a stored frame with a input frame, determining whether an inter-frame difference exists between the stored frame and the input frame, determining a degree of quantity of motion when an inter-frame difference is determined to exist, and changing the duration of the main back-light blanking in response to the determined degree of quantity of motion.

In accordance with another implementation, the apparatus for controlling main back-light frame blanking in liquid crystal displays includes a frame buffer configured to receive and store an input video frame, and an inter-frame analysis processor configured to receive the input video frame and to receive an output of the frame buffer. The inter-frame analysis processor determines whether an inter-frame difference exists between a stored frame and the input video frame and provides an output indicative of the determined difference. A main back-light frame blanking modulator receives the output of the inter-frame analysis processor and changes a pulse duration of the main back-light blanking in response to the determined difference.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a graphical representation of the principles of LEC backlight blanking showing differences between CRT and LCDs with and without backlight blanking;

FIG. 2 is an exemplary timing diagram of LCD backlight blanking distribution;

FIG. 3 is a flow diagram showing the method for adaptive backlight blanking in Liquid Crystal Displays according to an implementation of the invention; and

FIG. 4 is a block diagram of an apparatus for implementing the adaptive backlight blanking in Liquid Crystal Displays according to an implementation of the invention.

### DETAILED DESCRIPTION

The present invention is directed towards enhancing the reproduction of dynamic scenes on LCD monitors by controlling frame blanking of the display back-light

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

The present invention provides a method and apparatus for Adaptive Back-Light Frame Blanking in Liquid Crystal Displays improves the quality of video images, reproduced by picture monitors, based on LCD technology. The improvement relates to displaying of dynamic images, containing motion or scene changes. The viewers of those images will see less secondary motion blur that is being inflicted by the human visual system, and will see rather natural presentation of motion pictures and animation.

The present invention is directed towards enhancing the reproduction of dynamic scenes on LCD monitors by employing temporal control over the duration of frame blanking of the display back-light. Particularly, the greater the image difference between neighboring frames, the wider the main back-light frame blanking becomes, and vice versa—smaller image difference between consecutive frames will automatically inflict narrower main back-light blanking. The back light distribution is changing based on a logarithmic law, reflecting the perception of the Human Visual System (HVS). Main back light blanking is here understood to consist of the main interval, positioned between the video frames, when the back light is turned off, and a number of shorter back light blanking pulses, distributed during the active frame period. The sum of the main interval plus the shorter intervals remains constant, for the purpose of retaining constant display brightness. As the duration of the main interval changes, the total length of the shorter intervals changes proportionally in reverse direction. If the content of the neighboring frames is not much different in terms of scene object displacement, but the video level changes, then the method retains back-light blanking distribution within a small range. Also, when the scene returns from fast to slow dynamic images, the main back-light blanking restores its nominal duration and distribution.

In one implementation, the method reproduces image sequences, which exhibit reduced secondary motion blur, and is pleasant to watch. For best results, the method and apparatus relate the main back-light frame blanking in LCD monitors to the dynamic content of the reproduced video images.

The proposed method and apparatus are designed to improve the perceivable quality of video images that represent dynamic/motion scene on LCD monitors, equipped with LED back light. Those of skill in the art will recognize that there are two categories of methods for quality enhancement of dynamic images on LCD monitors, to which the present invention could be compared:

1) Methods for zonal LED back-light level control. These methods use LEDs as a light source for the LCD panel. The LEDs are positioned in a low density matrix behind the LCD panel—one LED covers up to a few hundreds of LCD elements. Every LED's light output is modulated proportionally to the incoming video levels for the LCD elements it covers. Neighboring LEDs could have different light outputs applied to their respective LCD group. This method counts on the contrast sensitivity of the HVS towards image borders between different bright objects.

The advantage of these methods is in improving the contrast quality of images on LCD monitors, including motion scenes. The disadvantage of the approach is that it fails to deal with the motion blur problem, which remains pronounced. With the advance of LCD technology, the contrast of the video monitors gets improved without applying special techniques, so the shortcomings of this method are more of a challenge today;

2) Methods for multiple blankings of the LED back-light during one video frame. These methods strobe the LED light numerous times per frame in an attempt to further reduce the appearance of blur on the human retina.

The advantage of these methods is that they distribute the blanking across the duration of a video frame, thus reducing a potential flicker. The disadvantage is in not fully addressing the problem of inflicted secondary motion blur on the HVS. The sample and hold nature of the LCD monitor remains a dominant factor for motion artifacts.

As is evident from the above, there have been a number of attempts to technically prevent the appearance of secondary motion blur on the HVS when the viewer is watching motion pictures, animation, video games, and other dynamic scenes on LCD display device. So far there is no recognized technology that satisfies this need.

Significant progress has been achieved in the domain of the LCD monitor technology, which has become a replacement of the classic CRT monitor and television set. Also, the last few years brought about the replacement of the fluorescent light as a light source for the LCD panel with a single LED, a set of LEDs, or a matrix of LEDs. This development created the opportunity to modulate in time the light source for the display.

A goal of the present invention is to use some features of the picture sequence in relation to the LED back light strobing in LCD displays, and for bringing the secondary motion blur on HVS below the threshold of visibility.

One distinctive characteristic of the back-light LED is its capability to switch speedily on and off during a video frame—an effect referred to in the art as flashing or strobing. This effect can happen multiple times during the video frame period. In addition, the LED as a back illumination source could emit high light output, which will compensate for the blanking instances during the video frame.

The present invention proposes to exercise adaptive temporal control of main back-light frame blanking distribution in LCD for dynamic images, while retaining constant light blacking duration.

While some of the prior art is capable of reducing the unwanted motion blur on FIVS, those of skill in the art will understand and appreciate that there remains blur remnants on the eye retina. This is due to unfinished process of rendering the frame blanking to bring down the aliasing. The method and apparatus for Adaptive Back-Light Frame Blanking in Liquid Crystal Displays of the present invention analyzes, in detail, the motion scene presented by the frame sequence, and automatically controls the back-light to further reduce further the blurring aliasing. Those of skill in the art will appreciate that the present method is applicable for any back-light source that is switchable fast enough during the video frame. The exemplary case of LED back-light present here is only one example.

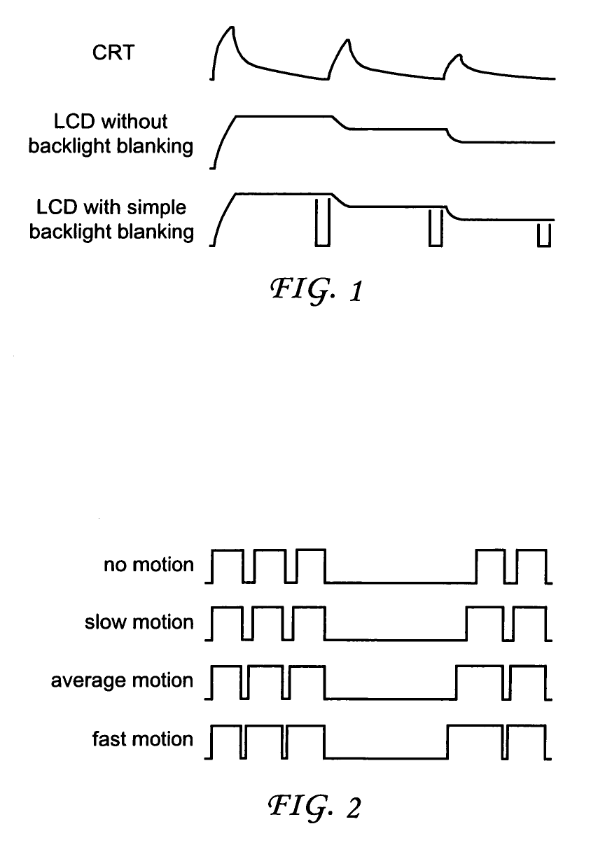

FIG. 1 shows a graphical representation of the principle of LCD main back-light blanking, compared to the classic CRT (which has natural light decay), and to LCD without main back-light blanking. As can be seen from this figure, the reduction of the back-light to zero acts as interruption to the sample-and-hold and operates to alleviate the blur in HVS.

In accordance with an implementation of the invention, the method is based on the introduction of a relation between the main back-light frame blanking and the image content. There is a variety of motion detection and motion analysis methods that could be applied to define the object displacement between consecutive frames. The displacement could be the result of scene motion, of camera zoom and pan, and also of animation in synthesized scenes. These methods require frame buffer to store neighboring frames for comparison. By employing such a buffer, the following concepts operate as the building blocks of the present invention:

1. The greater the inter-frame image difference, found by the motion analysis, the wider the main back-light frame blanking becomes. Thus, the present process automatically adapts to a larger object displacement. The smaller the inter-frame image difference, found by the motion analysis, the narrower the main back-light frame blanking becomes. This consideration introduces a temporal fill factor, which affects both the secondary motion blur, and the threshold of the latter within the visibility range. The larger the temporal fill factor, the more secondary motion blur could be reproduced without becoming perceived by the human eyes and brain. The smaller the temporal fill factor, the more strobe effect may occur without being perceived by the HVS. The method of the present invention controls the back-light distribution within the video frame to reflect this principle.

FIG. 2 shows the time-diagrams of the LCD back-light distribution for four cases of scene motion intensity (i.e., no motion, slow motion, average motion and fast motion). As shown, the wide pulse in each of the timing diagrams is the main back-light blanking time.

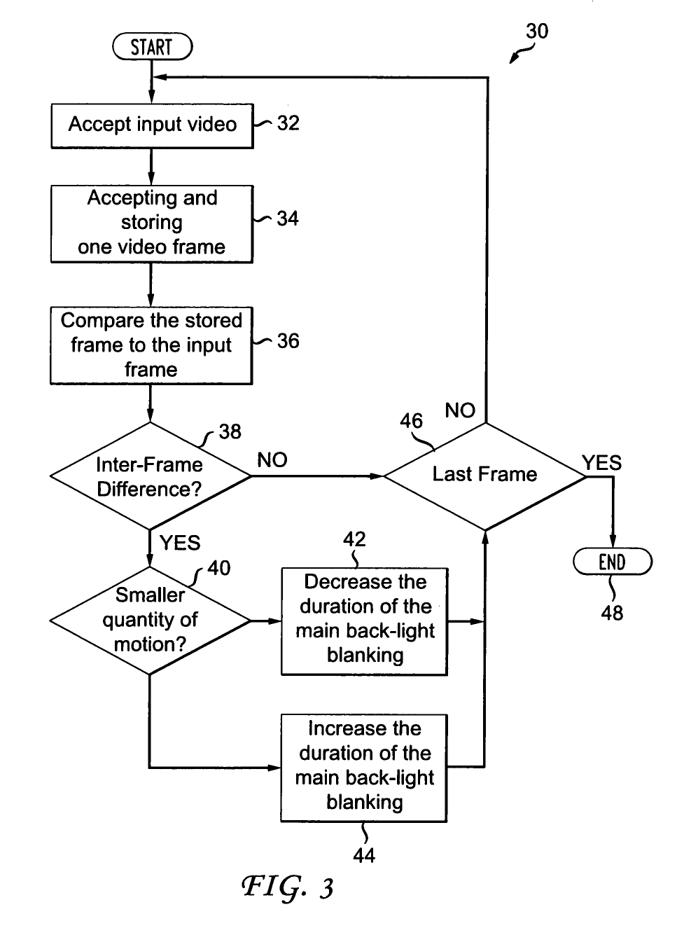

2. The relation between the inter-frame difference and the main back-light frame blanking is not necessarily straightforward. Rather, the relation is non-linear, in a manner that reflects the perceiving characteristics of the HVS. The method of the present invention provides a resolution of this non-linear relationship. Human eyes take an amount of sample-and-hold imagery, and then create secondary motion blur, proportionally to the object speed under a logarithmic law. This means that in a frame sequence with a large object displacement, the HVS needs a smaller amount of main back-light blanking than expected according to the linear law. The reverse is valid for frame sequences with small object displacement. The method of the present invention implements a variable back-light duration control, based on this described principle and is shown in FIG. 3.

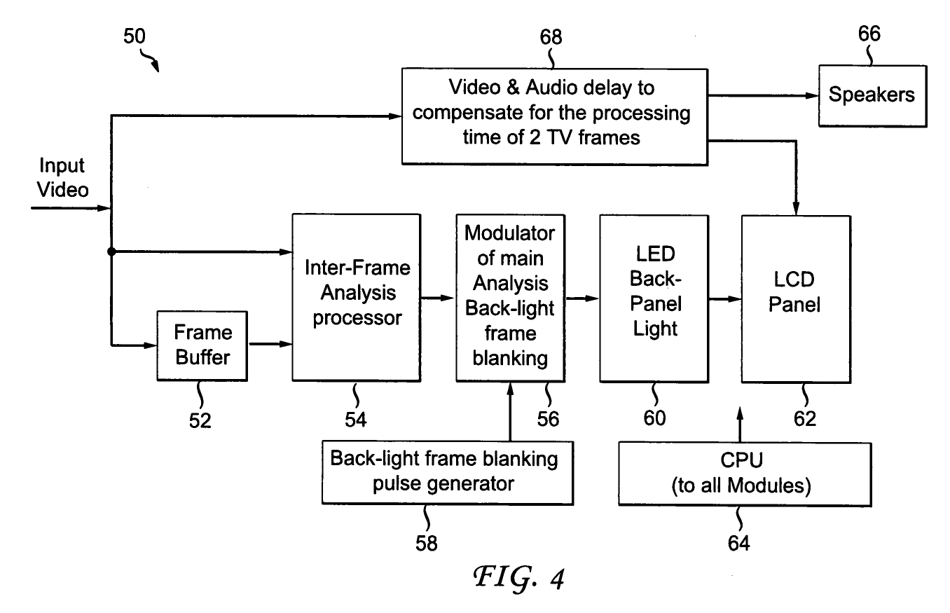

FIG. 3 shows the block diagram of the method 30 according to an implementation of the invention. As shown, initially the input video is accepted (32), and one video frame is accepted and stored (34) in the frame buffer (See FIG. 4). The stored frame is then compared with an input frame (36) and a determination is made (38) whether or not there is an inter-frame difference. This determination can be made, for example, in an inter-frame analysis processor (See for example, FIG. 4). Thus, if there is no inter-frame difference (i.e., the inter-frame video difference=0), a determination is made (46) whether this is the last frame, and if so, the process ends (48). It is assumed that the duration of the distributed main back-light blanking conforms to the accepted video standards for normal reproduction of video content in a video frame. If the inter-frame video difference is zero, the main back-light frame blanking distribution could be returned to its nominal status. The present invention is not restricted to a specific motion analysis method. As the simplest computation of the inter-frame difference, the pixel by pixel inter-frame comparison could be used to define the Quantity of Motion coefficient.

Those of skill in the art will recognize that there are a number of known methods for motion analysis, which could be called to define the inter-frame difference. Computation of the inter-frame difference (at step 38) will define a Quantity of Motion coefficient, which is to be used as a determinant in the main back-light blanking distribution algorithm. Thus, in the case when there is an inter-frame difference at step 38 (i.e., the difference is not equal to zero), a subsequent determination is made as to the smaller quantity of motion (step 40). Those of skill in the art will recognize that motion quantity is generally the sum of all pixel displacements between two consecutive frames. For example, one HDTV frame contains two million pixels. Thus if the motion is concentrated around one scene object, follow via an object tracking process, the sum in an example could be:

| | |
|---|---|
| Small object size | 1000 pixels |
| Medium object size | 10,000 pixels |
| Large object size | 100,000 pixels. |

Thus, the motion quantity, in its simplest form, could be measured by the number of pixel movement/displacements between frames:

For small object: 5,000 pixel displacement, or each of the 1000 object pixels has moved 5 pixels;

For medium object: 50,000 pixel displacement

For large object: 500,000 pixel displacement.

Thus, at step 40, a threshold determination is made. When a smaller quantity of motion is detected (i.e., below the predetermined threshold), the duration of the main back-light blanking is decreased (42), and the last frame determination (46) is made. When the smaller quantity of motion determination 40 results in a quantity of motion greater than the predetermined threshold, the duration of the main back-light is increase (44) and the last frame determination is again made. In accordance with one exemplary implementation, the motion threshold is adaptive depending on the object's size and their movement. Thus, in one example, the motion threshold can be in ranges of:

| | | |
|---|---|---|
| For a small object- | 5,000-15,000 | pixels displacement; |
| For a medium object- | 50,000-150,000 | pixels displacement; and |
| For a large object- | 500,000-1,500,000 | pixels displacement. |

Those of skill in the art will recognized that these motion threshold ranges are provided for exemplary purposes and can be changed depending on the sensitivity to motion desired.

FIG. 4 shows a basic block diagram of a display system 50 implementing the method of the present invention. The incoming video is applied directly to the Inter-frame analysis processor 54, and also indirectly to the analysis processor through a frame buffer 52. The resulting control data is passed to the Modulator 56 to change the pulse duration of the main back-light blanking. The pulse generator 58 synchronizes the process (i.e., by synchronizing the process with the input video stream. The modulated main back-light blanking pulse is applied to the LED matrix 60, which provides light for the LCD panel 62. The video and audio gets delayed 68 before being connected to the display section for time equalization. The CPU 64 which is in signal communication with all the elements acts as a master control of the process.

It is to be understood that the present invention may be implemented in various forms of hardware, software, firmware, special purpose processors, or a combination thereof. Preferably, the present invention would be implemented as a combination of hardware and software. Moreover, the software is preferably implemented as an application program tangibly embodied on a program storage device. The application program may be uploaded to, and executed by, a machine comprising any suitable architecture. Preferably, the machine would be implemented on a computer platform having hardware such as one or more central processing units (CPU), a random access memory (RAM), and input/output (110) interface(s). The computer platform also includes an operating system and microinstruction code. The various processes and functions described herein may either be part of the microinstruction code, or part of the application program (or a combination thereof), which is executed via the operating system. In addition, various other peripheral devices may be connected to the computer platform, such as an additional data storage device, and a printing device.

It is to be further understood that, because some of the constituent system components and method steps depicted in the accompanying figures are preferably implemented in software, the actual connections between the system components (or the process steps) may differ depending on the manner in which the present invention is programmed. The proposed innovations would not require a special training: The average operator in the related art will be able to utilize these and similar implementations or configurations of the present invention with the aid of the guidelines alone.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method for controlling main back-light frame blanking in liquid crystal displays, the method comprising the steps of:
comparing (36) a stored frame with an input frame;
determining (38) whether an inter-frame difference exists between the stored frame and the input frame;
determining (40) a degree of quantity of motion when an inter-frame difference is determined to exist; and
changing the duration (42, 44) of the main back-light blanking in response to the determined degree of quantity of motion.

2. The method of claim 1, further comprising the step of accepting and storing (34) a frame.

3. The method of claim 1, wherein said step of determining (40) a degree of quantity of motion further comprises establishing a threshold of quantity of motion.

4. The method of claim 3, wherein said step of changing the duration of the main back-light blanking further comprises;
decreasing the duration of the main back-light blanking when the threshold of quantity of motion is not exceeded; and
increasing the duration of the main back-light blanking when the threshold of quantity of motion is exceeded.

5. The method of claim 1, further comprising the step of determining (46) if the input frame is a last frame in a sequence of frames, and when it is not the last frame, repeating said steps of comparing (36), determining (38), determining (40) and changing (42,44) for a next frame.

6. The method of claim 3, wherein said establishing a threshold comprises establishing an adaptive threshold that is dependent on an object size.

7. The method of claim 6, wherein the establishing of the adaptive threshold comprises adopting the following threshold ranges:
5,000-15,000 pixels displacement for a small object;
50,000-150,000 pixels displacement for a medium object; and
500,000-1,500,000 pixels displacement for a large object.

8. An apparatus for controlling main back-light frame blanking in liquid crystal displays, the apparatus comprising:
a frame buffer (52) configured to receive and store an input video frame;
an inter-frame analysis processor (54) configured to receive an input video frame and to receive an output of the frame buffer; said inter-frame analysis processor determining whether an inter-frame difference exists between a stored frame and the input video frame and providing an output indicative of the determined difference; and
a main back-light frame blanking modulator (56) configured to receive the output of the inter-frame analysis processor and change a pulse duration of the main back-light blanking in response to the determined difference.

9. The apparatus of claim 8, wherein said inter-frame analysis processor (54) is further configured to identify a quantity of motion when an inter-frame difference is present, said quantity of motion having a non-linear relation to the duration of the main back-light blanking.

10. The apparatus of claim 8, further comprising a back-light frame blanking pulse generator (58) connected to the main back-light frame blanking modulator and configured to synchronize the change in pulse duration of the main back-light blanking with respect to the input video.

11. An apparatus for controlling main back-light frame blanking in liquid crystal displays, the apparatus comprising the steps of:
means for comparing (54) a stored frame with an input frame;
means for determining (54) whether an inter-frame difference exists between the stored frame and the input frame;
means for determining (54) a degree of quantity of motion when an inter-frame difference is determined to exist; and
means for changing the duration (58) of the main back-light blanking in response to the determined degree of quantity of motion.

12. The apparatus of claim 11, wherein said means for determining (54) a degree of quantity of motion further comprises means for establishing a threshold of quantity of motion.

13. The apparatus of claim 12, wherein said means for changing (58) the duration of the main back-light blanking decreases the duration of the main back-light blanking when the threshold of quantity of motion is not exceeded, and increases the duration of the main back-light blanking when the threshold of quantity of motion is exceeded.

14. The apparatus of claim 11, further comprising means (52) for receiving and storing a frame.
